(19) United States
(12) Patent Application Publication
(10) Pub. No.: US 2025/0149795 A1
(43) Pub. Date: May 8, 2025

(54) Circularly Polarized Satellite Antenna Based on Magnetoelectric Dipole

(71) Applicant: Micronet Union Technology (Chengdu) Co., Ltd., Chengdu (CN)

(72) Inventors: Tao Chen, Chengdu (CN); Mengya Liu, Chengdu (CN); Chunsheng Huang, Chengdu (CN); Yuandan Dong, Chengdu (CN); Yufei Fan, Chengdu (CN); Qiming Liang, Chengdu (CN)

(21) Appl. No.: 18/930,980

(22) Filed: Oct. 29, 2024

(30) Foreign Application Priority Data
Nov. 7, 2023 (CN) 2023114655794

(51) Int. Cl. H01Q 9/06; H01Q 1/28; H01Q 5/378; H01Q 21/06

(52) U.S. Cl. CPC H01Q 9/065; H01Q 1/288; H01Q 5/378; H01Q 21/062

(57) ABSTRACT

The present disclosure discloses a circularly polarized satellite antenna based on a magnetoelectric dipole. A floor is slotted, and an equivalent magnetoelectric dipole is excited using a grounded right-angle folded dipole, while two square parasitic patches are loaded to enhance a radiation performance, thus exciting a broadband high-gain circularly polarized radiation beam. The present disclosure utilizes the L-shaped right-angle folded dipole to simultaneously realize an ingenious combination of an electric dipole and a magnetic dipole, realizing a good circularly polarized radiation performance. At the same time, the present disclosure realizes circularly polarized radiation using a form of the magnetic dipole, which results in a stable pattern and a high gain.

### TECHNICAL FIELD

The present disclosure belongs to the technical field of satellite communication antennas, and specifically relates to a design of a circularly polarized satellite antenna based on a magnetoelectric dipole.

### BACKGROUND

As times continue to evolve, communication systems are iterating faster and faster. Now it has entered the 5G era, the number of mobile communication terminals is also growing exponentially, which brings huge challenges and opportunities to mobile communications.

An antenna serves as an essential and important component in a communication system, so its performance plays a decisive role in a quality of the whole communication system. In order to meet a huge demand for coping with communications traffic, it is necessary to lay more base stations on an original basis and reduce a distance between each base station and others, so as to achieve purposes of covering a larger area as well as increasing a data capacity. However, with the arrival of the 5G era, original base station site resources become tight, and there is an urgent need to develop a new communication mode to change the existing situation. Under this background, a satellite communication system has emerged.

The satellite communication system consists of three parts, namely, airborne satellite groups, terrestrial gateway stations and satellite communication terminals, and the satellite communication terminals, as important tools for information interactions between users and satellites, play a vital role in the whole system. Satellite communication antennas are terminal devices used to communicate with the satellites in Earth orbit, and they are a vital component the satellite communication system, as they are responsible for receiving and relaying signals sent by the satellites to the terrestrial gateway stations or other satellites.

In order to meet the requirements that beams of the mobile satellite communication terminals need to be aligned with orientations of the satellites at all times, mechanical scanning, electrical scanning and a combination of the two are usually used to realize an effect of beam scanning of the satellite antennas. Application frequency bands of the satellite antennas are mostly millimeter-wave frequency bands to avoid occupying existing communication frequency bands. An electromagnetic wave in the millimeter wave band has a large loss in space, and gains of the antennas need to be designed to be large enough to meet use demands of long-distance transmission and reception in a design of practical applications, so phased arrays with a large number of array elements are generally used as the satellite antennas of the satellite terminals. In addition, in order to overcome a multipath loss effect, most of the satellite antennas are circularly polarized antennas as array elements.

At present, development directions of the satellite communication antennas are mainly reflected in the following aspects: (1) miniaturization: with a continuous development of a satellite communication technology, the satellite communication antennas are gradually developing in a direction of miniaturization. Miniaturized satellite communication antennas can reduce costs, sizes and weights, making them more suitable for application scenarios such as small satellites and unmanned aerial vehicles. (2) High-frequency-band application: with a continuous development of a high-frequency-band communication technology, more and more satellite communication systems begin communications in high frequency bands such as a Ka band and a Q/V band, so corresponding antennas are needed to realize the high-frequency-band communications. (3) Adaptive beam technology: the adaptive beam technology is a novel satellite communication antenna technology, which can dynamically adjust directions and shapes of the beams according to communication environments and data transmission demands, so as to improve efficiency and reliability of signal transmission. (4) Intellectualization: intellectualization is one of important directions for a future development of the satellite communication antennas. By adding intelligent software and algorithms, automatic control and optimization of the satellite communication antennas can be realized to improve communication efficiency and reliability.

For current satellite communication antennas, precise pointing of the terrestrial stations is required, such that the satellite antennas usually require high gains as well as cross-polarization ratios to achieve optimal signal reception and transmission, which may bring additional costs and technical difficulties for some application scenarios. Meanwhile, some of the current high-performance satellite communication antennas have high processing costs, which may limit their wide applications in some application scenarios. For example, in some application scenarios such as small satellites and unmanned aerial vehicles, smaller, lighter and cheaper antennas are needed. In addition, for radiation pattern performances of the current satellite antennas, since spacing between the array elements of the phased array antennas is usually half of a wavelength of a center frequency, coupling thereof is serious, which leads to a high minor level of an antenna array pattern affecting the normal use of the antennas.

### SUMMARY

An objective of the present disclosure is to solve the above problems of existing satellite communication antennas. A circularly polarized satellite antenna based on a magnetoelectric dipole is proposed and can excite a broadband high-gain circularly polarized radiation beam.

A technical solution of the present disclosure is: a circularly polarized satellite antenna based on a magnetoelectric dipole includes a layer of floor, a feed port, a microstrip feed wire, two grounded short-circuit through holes, a rectangular slit, two parasitic patches and two folded dipoles. The floor is slotted with the half-wavelength rectangular slit. The microstrip feed wire orthogonal to the rectangular slit is disposed under the rectangular slit. One end of the microstrip feed wire is connected to the feed port. The two folded dipoles are both in an L shape and are both disposed in a plane a quarter wavelength from an upper portion of the floor. A first dipole arm of one of the folded dipoles is parallel to the microstrip feed wire, and a second dipole arm thereof is disposed on one side of the rectangular slit. A first dipole arm of another of the folded dipoles is parallel to the microstrip feed wire, and a second dipole arm thereof is disposed on another side of the rectangular slit. Each of the folded dipoles is connected to the floor through one of the grounded short-circuit through holes respectively. The two grounded short-circuit through holes are located on two sides of the rectangular slit respectively. The two parasitic patches are disposed in a plane where the two folded dipoles are located, and the two parasitic patches are located on L-shaped inner sides of the two folded dipoles respectively.

Further, the microstrip feed wire is used to excite an operating mode of the rectangular slit.

Further, the folded dipoles are used to excite an electromagnetic wave parallel to a polarization direction of the rectangular slit to constitute an electric dipole together with the grounded short-circuit through holes, and meanwhile to excite a magnetic dipole formed through the grounded short-circuit through holes and the rectangular slit together so as to form the magnetoelectric dipole.

Further, the parasitic patches are used to improve a circularly polarized radiation performance of the antenna.

Further, the circularly polarized satellite antenna is used as an antenna array element, four antenna array elements are arranged in a form of 2*2 and constitute a subarray in a 90° rotating feed setting, and four subarrays are arranged in a form of 2*2 to constitute an antenna array.

Further, the floor is used as a common floor for the whole antenna array and is used to enable a maximum radiation direction orientation to be perpendicular to a direction of the floor when the whole antenna array operates.

Further, the floor is made of a PCB substrate of an Isola Tachyon 100 material, and a metal material printed on PCB substrate is copper.

Further, a design frequency band of the circularly polarized satellite antenna is a Ka band.

Further, the folded dipoles are made of folded microstrip lines with a width of 1.9 mm.

The present disclosure has the following beneficial effects.
(1) The present disclosure utilizes the L-shaped right-angle folded dipoles to simultaneously realize an ingenious combination of an electric dipole and a magnetic dipole, realizing a good circularly polarized radiation performance.
(2) The present disclosure realizes circularly polarized radiation using a form of the magnetic dipole, which results in a stable pattern and a high gain.
(3) The present disclosure loads the square parasitic patches on the inner sides of the dipoles, which adjusts an electric field amplitude in the two polarization directions of the antenna, thus improving an axial ratio of circularly polarized radiation.
(4) The present disclosure uses the narrow microstrip dipoles to realize the circularly polarized radiation, realizing an effect of miniaturization.
(5) The present disclosure has a simple structure, composed of a total of two layers of substrates and three layers of metal which are respectively the microstrip feed wire on a bottom layer, the floor slit in a middle layer, and the L-shaped folded dipoles as well as the square parasitic patches on a top layer, which is small in size and low in cost, and can be used in application scenarios such as a small satellite and an unmanned aerial vehicle.
(6) The present disclosure uses a design of the PCB substrates, which is convenient to process and has a small error.

### BRIEF DESCRIPTION OF DRAWINGS

FIG. 1 is a schematic 3D diagram of a circularly polarized satellite antenna based on a magnetoelectric dipole provided by an embodiment of the present disclosure.

FIG. 2 is a top view of a circularly polarized satellite antenna based on a magnetoelectric dipole provided by an embodiment of the present disclosure.

FIG. 3 is a schematic 3D diagram of an antenna array provided by an embodiment of the present disclosure.

FIG. 4 is a top view of an antenna array provided by an embodiment of the present disclosure.

FIG. 5 is a schematic diagram of reflection coefficients of a feed port in a case where a scanning angle of a main beam is 0° and 30° provided by an embodiment of the present disclosure.

FIG. 6 is a schematic diagram of an axial ratio of a main beam direction in a case where a scanning angle of a main beam is 0° and 30° provided by an embodiment of the present disclosure.

FIG. 7 is a diagram of a radiation direction when a scanning angle of a main beam is 0° provided by an embodiment of the present disclosure.

FIG. 8 is a diagram of a radiation direction when a scanning angle of a main beam is 30° provided by an embodiment of the present disclosure.

Description of reference numerals: 1—floor, 2—feed port, 3—microstrip feed wire, 4—grounded short-circuit through hole, 5—rectangular slit, 6—parasitic patch, and 7—folded dipole.

### DETAILED DESCRIPTION

Exemplary implementations of the present disclosure will now be described in detail with reference to accompanying drawings. It should be understood that the implementations illustrated and described in the accompanying drawings are merely exemplary, are intended to elucidate the principle and spirit of the present disclosure, and are not intended to limit the scope of the present disclosure.

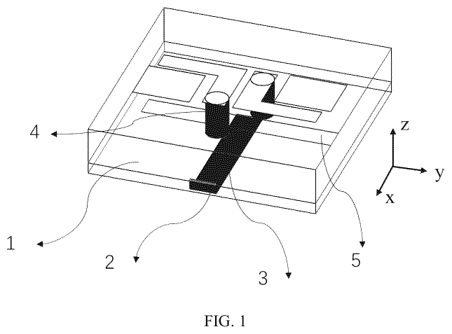

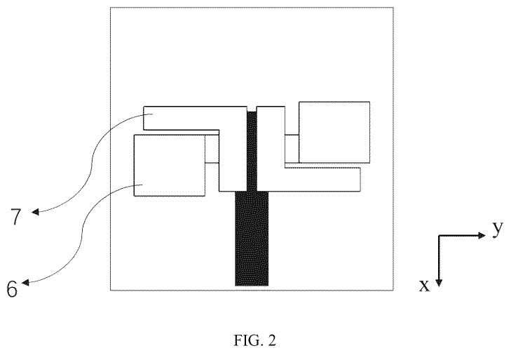

An embodiment of the present disclosure provides a circularly polarized satellite antenna based on a magnetoelectric dipole, as shown in FIG. 1 and FIG. 2 together, including a layer of floor 1, a feed port 2, a microstrip feed wire 3, two grounded short-circuit through holes 4, a rectangular slit 5, two parasitic patches 6 and two folded dipoles 7.

The floor 1 is slotted with the half-wavelength rectangular slit 5. The microstrip feed wire 3 orthogonal to the rectangular slit 5 is disposed under the rectangular slit 5. One end of the microstrip feed wire 3 is connected to the feed port 2. The two folded dipoles 7 are both in an L shape and are both disposed in a plane a quarter wavelength from an upper portion of the floor 1. A first dipole arm of one of the folded dipoles 7 is parallel to the microstrip feed wire 3, and a second dipole arm thereof is disposed on one side of the rectangular slit 5. A first dipole arm of another of the folded dipoles 7 is parallel to the microstrip feed wire 3, and a second dipole arm thereof is disposed on another side of the rectangular slit 5. Each of the folded dipoles 7 is connected to the floor 1 through one of the grounded short-circuit through holes 4 respectively, The two grounded short-circuit through holes 4 are located on two sides of the rectangular slit 5 respectively. The two parasitic patches 6 are disposed in a plane where the two folded dipoles 7 are located, and the two parasitic patches 6 are located on L-shaped inner sides of the two folded dipoles 7 respectively.

In the embodiment of the present disclosure, the half wavelength and the quarter wavelength are both wavelengths for a center frequency point of an operating frequency band of the antenna.

In the embodiment of the present disclosure, the microstrip feed wire 3 is used to excite an operating mode of the rectangular slit 5.

In the embodiment of the present disclosure, the folded dipoles 7 are used to excite an electromagnetic wave parallel to a polarization direction of the rectangular slit 5 to constitute an electric dipole together with the grounded short-circuit through holes 4, and meanwhile to excite a magnetic dipole formed through the grounded short-circuit through holes 4 and the rectangular slit 5 together so as to form the magnetoelectric dipole.

In the embodiment of the present disclosure, the folded dipoles 7 and the grounded short-circuit through holes 4 together form the electric dipole, which results in opposite currents on the grounded short-circuit through holes 4 due to opposite potentials on the two sides of the rectangular slit 5 when the rectangular slit 5 is excited. At the same time, since two different ends of folded portions of the folded dipoles 7 are connected to the different grounded short-circuit through holes 4, currents thereof are in the same direction, just enough to form a current loop between the grounded short-circuit through holes 4 and the rectangular slit 5, i.e., to form the magnetic dipole. Through coupling of the rectangular slit 5, the electric dipole and the magnetic dipole are excited simultaneously to form the magnetoelectric dipole. Polarization directions of electric fields excited by the magnetic dipole and the electric dipole are orthogonal to each other, and differ by a phase difference of 90° in a far-field region, thus forming circularly polarized radiation.

In the embodiment of the present disclosure, the parasitic patches 6 are used to improve a circularly polarized radiation performance of the antenna. Since connections between the grounded short-circuit through holes 4 and the dipole arms of the L-shaped folded dipoles 7 unavoidably result in a difference in amplitudes of far-field radiation of the electric dipole and the magnetic dipole, the two parasitic patches 6 are loaded in the plane at the same height of the folded dipoles 7 in order to adjust amplitudes of electric-field components in the two orthogonal polarization directions of the antenna. The parasitic patches 6 in the embodiment of the present disclosure use square parasitic patches for enhancing a radiation intensity of the magnetic dipole to be nearly equal to the amplitudes of the orthogonal directions, thereby generating standard circularly polarized radiation and expanding an aperture of the antenna to achieve a high gain performance of a main beam.

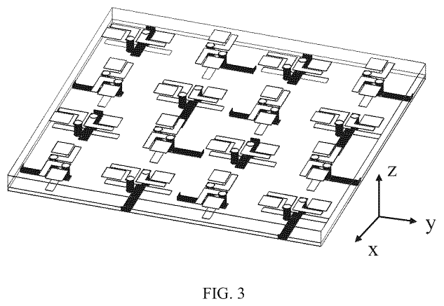

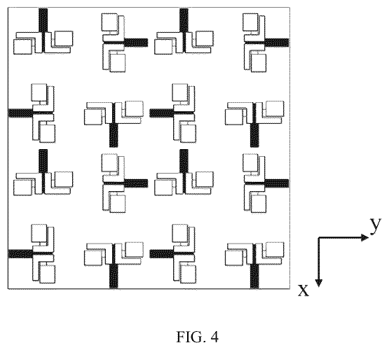

In the embodiment of the present disclosure, as shown in FIG. 3 and FIG. 4 together, the circularly polarized satellite antenna is used as an antenna array element, four antenna array elements are arranged in a form of 2*2 and constitute a subarray in a 90° rotating feed setting, and four subarrays are arranged in a form of 2*2 to constitute an antenna array. The 90° rotating feed setting in the subarray realizes a high axial ratio performance while realizing a high gain.

In the embodiment of the present disclosure, the floor 1 is used as a common floor for the whole antenna array and is used to enable a maximum radiation direction orientation to be perpendicular to a direction (i.e., a positive z-axis direction in FIG. 2 and FIG. 4) of the floor 1 when the whole antenna array operates.

In the embodiment of the present disclosure, the floor 1 is made of a PCB substrate of an Isola Tachyon 100 material, and a metal material printed on the PCB substrate is copper.

In the embodiment of the present disclosure, a design frequency band of the circularly polarized satellite antenna is a Ka band (27-40 GHZ).

In the embodiment of the present disclosure, the folded dipoles 7 are made of folded microstrip lines with a width of 1.9 mm, realizing an effect of miniaturization of the antenna.

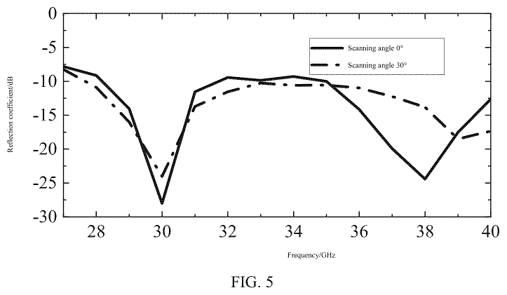

FIG. 5 shows reflection coefficients of the feed port 2 in a case where a scanning angle of the main beam of the circularly polarized satellite antenna is 0° and 30° provided by an embodiment of the present disclosure, manifesting that the circularly polarized satellite antenna has a good impedance matching bandwidth.

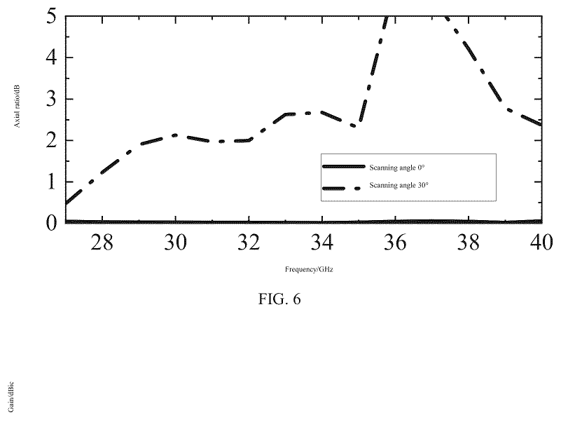

FIG. 6 shows an axial ratio of a main beam direction in a case where the scanning angle of the main beam of the circularly polarized satellite antenna is 0° and 30° provided by an embodiment of the present disclosure, manifesting that the circularly polarized satellite antenna can maintain a good circularly polarized effect in the main beam direction of its radiation at different scanning angles.

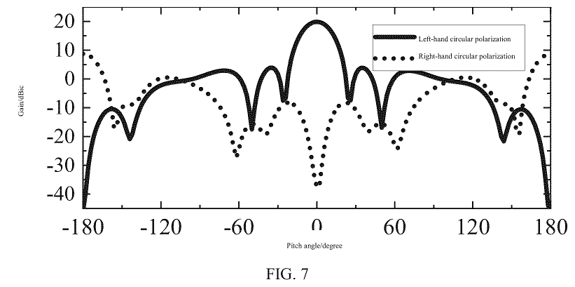

FIG. 7 is a diagram of a radiation direction when the scanning angle of the main beam of the circularly polarized satellite antenna is 0° provided by an embodiment of the present disclosure, manifesting that the circularly polarized satellite antenna has a high realizable gain as well as a good cross-polarization ratio, while realizing a low minor level.

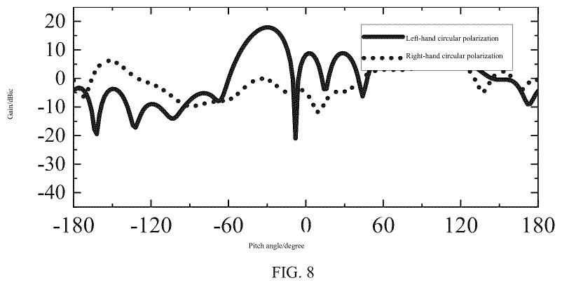

FIG. 8 is a diagram of a radiation direction when the scanning angle of the main beam of the circularly polarized satellite antenna is 30° provided by an embodiment of the present disclosure, manifesting that the circularly polarized satellite antenna has a high realizable gain as well as a good cross-polarization ratio, while realizing a low minor level.

Those of ordinary skill in the art will realize that the embodiments described herein are intended to assist the reader in understanding the principle of the present disclosure, and it should be understood that the scope of protection of the present disclosure is not limited to such particular statements and embodiments. Those of ordinary skill in the art may make various other specific variations and combinations not departing from the essence of the present disclosure according to these technical inspirations disclosed herein, and these variations and combinations are still within the scope of protection of the present disclosure.

What is claimed is:

1. A circularly polarized satellite antenna based on a magnetoelectric dipole, comprising a layer of floor (1), a feed port (2), a microstrip feed wire (3), two grounded short-circuit through holes (4), a rectangular slit (5), two parasitic patches (6) and two folded dipoles (7); wherein
the floor (1) is slotted with the half-wavelength rectangular slit (5), the microstrip feed wire (3) orthogonal to the rectangular slit (5) is disposed under the rectangular slit (5), one end of the microstrip feed wire (3) is connected to the feed port (2), the two folded dipoles (7) are both in an L shape and are both disposed in a plane a quarter wavelength from an upper portion of the floor (1), a first dipole arm of one of the folded dipoles (7) is parallel to the microstrip feed wire (3), a second dipole arm thereof is disposed on one side of the rectangular slit (5), a first dipole arm of another of the folded dipoles (7) is parallel to the microstrip feed wire (3), a second dipole arm thereof is disposed on another side of the rectangular slit (5), each of the folded dipoles (7) is connected to the floor (1) through one of the grounded short-circuit through holes (4) respectively, the two grounded short-circuit through holes (4) are located on two sides of the rectangular slit (5) respectively, the two parasitic patches (6) are disposed in a plane where the two folded dipoles (7) are located, and the two parasitic patches (6) are located on L-shaped inner sides of the two folded dipoles (7) respectively.

2. The circularly polarized satellite antenna according to claim 1, wherein the microstrip feed wire (3) is used to excite an operating mode of the rectangular slit (5).

3. The circularly polarized satellite antenna according to claim 1, wherein the folded dipoles (7) are used to excite an electromagnetic wave parallel to a polarization direction of the rectangular slit (5) to constitute an electric dipole together with the grounded short-circuit through holes (4), and meanwhile to excite a magnetic dipole formed through the grounded short-circuit through holes (4) and the rectangular slit (5) together so as to form the magnetoelectric dipole.

4. The circularly polarized satellite antenna according to claim 1, wherein the parasitic patches (6) are used to improve a circularly polarized radiation performance of the antenna.

5. The circularly polarized satellite antenna according to claim 1, wherein the circularly polarized satellite antenna is used as an antenna array element, four antenna array elements are arranged in a form of 2*2 and constitute a subarray in a 90° rotating feed setting, and four subarrays are arranged in a form of 2*2 to constitute an antenna array.

6. The circularly polarized satellite antenna according to claim 5, wherein the floor (1) is used as a common floor for the whole antenna array and is used to enable a maximum radiation direction orientation to be perpendicular to a direction of the floor (1) when the whole antenna array operates.

7. The circularly polarized satellite antenna according to claim 1, wherein the floor (1) is made of a PCB substrate of an Isola Tachyon 100 material, and a metal material printed on the PCB substrate is copper.

8. The circularly polarized satellite antenna according to claim 1, wherein a design frequency band of the circularly polarized satellite antenna is a Ka band.

9. The circularly polarized satellite antenna according to claim 1, wherein the folded dipoles (7) are made of folded microstrip lines with a width of 1.9 mm.
